(19) United States
(12) Patent Application Publication
(10) Pub. No.: US 2005/0164021 A1
(43) Pub. Date: Jul. 28, 2005

(54) Resin composition and multilayer structure including the same

(75) Inventors: Kaoru Inoue, Osaka-shi (JP); Takamasa Morimaya, Osaka-shi (JP); Takeo Yamamoto, Osaka-shi (JP)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: The Nippon Synthetic Chemical Industry Co., Ltd., Osaka (JP)

(21) Appl. No.: 10/519,593

(22) PCT Filed: Jun. 24, 2003
(86) PCT No.: PCT/JP03/07978

(30) Foreign Application Priority Data
Jun. 24, 2002 (JP) 2002-182340

(51) Int. Cl. B32B 27/08

(52) U.S. Cl. 428/474.4; 428/480; 428/500; 524/355; 524/563

(57) ABSTRACT

The present invention provides a resin composition comprising a saponified ethylene-vinyl acetate copolymer (A) and a substituted 9,10-anthraquinone (B) having a substituent at at least one of the 2-, 3-, 6- and 7-positions and showing a percent weight loss when stood with heating at 250° C. for 60 minutes of not more than 5% and a multilayer structure including the resin composition as an intermediate layer. This multilayer structure is superior in appearance, oxygen barrier property, further forming stability, resistance to pinholes, adhesion between layers and the like, and is useful for packaging of foods such as meat, ketchup, soybean paste, beer and the like.

### TECHNICAL FIELD

The present invention relates to a saponified ethylene-vinyl acetate copolymer (hereinafter to be abbreviated as EVOH) composition and a multilayer structure thereof. More particularly, the present invention relates to an EVOH composition useful for obtaining a laminate structure superior in oxygen barrier property and appearance, particularly forming stability upon processing at high temperature, and further, adhesion between layers and a multilayer structure using the composition.

### BACKGROUND ART

In general, EVOH is a resin superior in gas barrier property, transparency, melt formability and the like, and is known to suppress deterioration of food when used as a material for packaging food, by functionally blocking oxygen.

Improved oxygen barrier property has been desired in recent years to increase safety of food. In addition, the food highly sensitive to oxygen, which has been preserved in metal and glass bottles, also tends to be preserved in plastic containers due to ease of use. In this case, too, higher oxygen barrier property is requested.

On the other hand, since not only external oxygen but also oxygen remaining inside by being enclosed with a packaging material used for packaging the food have a possibility of deteriorating the food, removal of such oxygen has been desired.

From such background, a resin composition capable of physically blocking the external oxygen and absorbing internal oxygen as well has been considered.

For example, JP-A-8-238726 describes a laminate having at least two layers of a layer for physically blocking the oxygen and a layer for chemically absorbing the oxygen, wherein the layer for chemically absorbing the oxygen is an alloy mainly comprising aluminum; JP-A-11-151783 describes a laminate comprising an oxygen barrier layer and an oxygen absorptive layer as intermediate layers, wherein the oxygen absorptive layer comprises a composition of a thermoplastic resin, a reduced iron and a halogenated metal, JP-T-8-504851 describes a laminate comprising, as an intermediate layer, a composition comprising an anthraquinone compound and a polymer, JP-T-11-504666 describes oxygen capture material comprising an anthraquinone compound in an oxygen impermeable section or microcapsule, JP-A-3-197566 describes a laminate structure comprising a composition wherein polyhydric phenol and an electron donating substance are added to EVOH as an intermediate layer, JP-T-8-502202 describes a laminate structure comprising a composition wherein a cobalt catalyst and a photoinitiator are added to a polymer having an unsaturated hydrocarbon bond, U.S. Pat. No. 6,037,022 describes a food container comprising a laminate comprising a composition wherein iron carbonate is added to EVOH and JP-A-2-298579 describes a laminate comprising a composition wherein reduced iron is added to EVOH.

The present applicant has made further improvements in the respective techniques disclosed above and a multilayer structure having a layer of a resin composition comprising EVOH and a substituted 9,10-anthraquinone having a substituent at at least one of the 2-, 3-, 6- and 7-positions (Japanese Patent Application No. 2001-299898).

When the above-mentioned multilayer structure that the resent applicant proposed is produced in a general melt-forming temperature range of about 220° C., a multilayer structure superior in formability, adhesion between layers, resistance to pinholes, resistance to delamination and the like can be obtained, but a resin composition having fine high speed formability has been recently desired from the market, which sometimes results in forming at a relatively high temperature of about 250° C. rather than the conventional forming temperature of about 220° C. When formed at such temperature, the forming stability is degraded and the adhesion between layers shows a slight decrease, thus leaving room for improvement.

### DISCLOSURE OF THE INVENTION

The present inventors have conducted intensive studies in view of the above-mentioned situation and found that a resin composition comprising EVOH (A) and substituted 9,10-anthraquinone (B) having a substituent at at least one of the 2-, 3-, 6- and 7-positions and showing a percent weight loss when stood with heating at 250° C. for 60 minutes of not more than 5% meets the above-mentioned object, which resulted in the completion of the present invention.

When producing a resin composition containing the above-mentioned (A) and (B) in the present invention, moreover, a substituted 9,10-anthraquinone (B) having a substituent at at least one of the 2-, 3-, 6- and 7-positions and showing a percent weight loss when stood with heating at 250° C. for 60 minutes of not more than 5% is melt-mixed with EVOH (A) having a water content of not more than 60 wt % (preferably 20-60 wt %) in an extruder, whereby the action and effect of the present invention is remarkably exhibited.

In the present invention, moreover, addition of 0.001-0.5 equivalent of acid (C) to a substituted 9,10-anthraquinone (B) having a substituent at at least one of the 2-, 3-, 6- and 7-positions and showing a percent weight loss when stood with heating at 250° C. for 60 minutes of not more than 5% further exhibits the effect of the present invention.

In a specific layer constitution of a multilayer structure using the resin composition of the present invention, the resin composition layer is preferably an intermediate layer, and at least one layer of the inner and outer layers is preferably a layer containing a resin selected from a polyolefin resin, a polyamide resin and a polyester resin.

Accordingly, the present invention provides the following.

(1) A resin composition comprising a saponified ethylene-vinyl acetate copolymer (A) and a substituted 9,10-anthraquinone (B) having a substituent at at least one of the 2-, 3-, 6- and 7-positions and showing a percent weight loss when stood with heating at 250° C. for 60 minutes of not more than 5%.

(2) The resin composition of the above-mentioned (1), wherein the substituted 9,10-anthraquinone (B) having a substituent at at least one of the 2-, 3-, 6- and 7-positions and showing a percent weight loss when stood with heating at 250° C. for 60 minutes of not more than 5% is water-soluble.

(3) The resin composition of the above-mentioned (1) or (2), wherein substituted 9,10-anthraquinone (B) having a substituent at at least one of the 2-, 3-, 6- and 7-positions and showing a percent weight loss when stood with heating at 250° C. for 60 minutes of not more than 5% is sodium anthraquinone-sulfonate or disodium anthraquinone-disulfonate.

(4) The resin composition of any of the above-mentioned (1)-(3), wherein the content of the substituted 9,10-anthraquinone (B) having a substituent at at least one of the 2-, 3-, 6- and 7-positions and showing a percent weight loss when stood with heating at 250° C. for 60 minutes of not more than 5% is 0.5-10 wt % relative to the saponified ethylene-vinyl acetate copolymer (A).

(5) The resin composition of any of the above-mentioned (1)-(4), further comprising an acid (C) in 0.001-0.5 equivalent of the substituted 9,10-anthraquinone (B) having a substituent at at least one of the 2-, 3-, 6- and 7-positions and showing a percent weight loss when stood with heating at 250° C. for 60 minutes of not more than 5%.

(6) The resin composition of any of the above-mentioned (1)-(5), which is obtained by melt-mixing a saponified ethylene-vinyl acetate copolymer (A) having a water content of not more than 60 wt % and a substituted 9,10-anthraquinone (B) having a substituent at at least one of the 2-, 3-, 6- and 7-positions and showing a percent weight loss when stood with heating at 250° C. for 60 minutes of not more than 5% in an extruder.

(7) A laminate structure comprising a layer made of the resin composition of any of the above-mentioned (1)-(6) as an intermediate layer, and at least one layer of inner and outer layers comprises a resin selected from a polyolefin resin, a polyamide resin and a polyester resin.

(8) The laminate structure of the above-mentioned (7), wherein the inner and outer layers comprises a polyolefin resin.

(9) The resin composition of the above-mentioned (6), wherein the saponified ethylene-vinyl acetate copolymer (A) has a water content of 20-60 wt %.

### BEST MODE FOR CARRYING OUT THE INVENTION

The present invention is described in detail in the following.

While the EVOH (A) to be used in the present invention is not particularly limited, the ethylene content is preferably 5-50 mol % (further 10-50 mol %, particularly 20-50 mol %, especially 25-50 mol %). When the ethylene content is less than 5 mol %, the water resistance becomes insufficient and when it exceeds 50 mol %, the gas barrier property is unpreferably degraded.

The saponification degree of the vinyl acetate component is preferably not less than 90 mol % (further not less than 95 mol %, particularly not less than 99 mol %, especially not less than 99.5 mol %). When the saponification degree is less than 90 mol %, the gas barrier property and heat resistance unpreferably becomes insufficient.

Furthermore, the melt flow rate (MFR) (210° C., load: 2160 g) is preferably 0.1-50 g/10 min (further 1-30 g/10 min, particularly 2-20 g/10 min, especially 5-15 g/10 min). When the MFR is less than 0.1 g/10 min, the resin pressure becomes high during melt-forming, making the forming difficult, and when it conversely exceeds 50 g/10 min, the resulting formed product unpreferably shows decreased resistance to pinholes.

The above-mentioned EVOH (A) may comprise a copolymerizable ethylenically unsaturated monomer copolymerized therein, as long as the object of the present invention is not impaired. As such monomer, olefins such as propylene, 1-butene, isobutene and the like, unsaturated acids such as acrylic acid, methacrylic acid, crotonic acid, phthalic acid (phthalic anhydride), maleic acid (maleic anhydride), itaconic acid (itaconic anhydride) and the like or a salt thereof or mono- or di-alkyl ester thereof having 1 to 18 carbon atoms, acrylamides such as acrylamide, N-alkylacrylamide having 1 to 18 carbon atoms, N,N-dimethylacrylamide, 2-acrylamidepropanesulfonic acid or a salt thereof, acrylamidepropyldimethylamine or an acid salt thereof or a quaternary salt thereof and the like, methacrylamides such as methacrylamide, N-alkylmethacrylamide having 1 to 18 carbon atoms, N,N-dimethyl methacrylamide, 2-methacrylamidepropanesulfonic acid or a salt thereof, methacrylamidepropyldimethylamine or an acid salt thereof or a quaternary salt thereof and the like, N-vinylamides such as N-vinylpyrrolidone, N-vinylformamide, N-vinylacetamide and the like, cyanated vinyls such as acrylonitrile, methacrylonitrile and the like, vinyl ethers such as alkylvinyl ether having 1 to 18 carbon atoms, hydroxyalkylvinyl ether, alkoxyalkylvinyl ether and the like, halogenated vinyls such as vinyl chloride, vinylidene chloride, vinyl fluoride, vinylidene fluoride, vinyl bromide and the like, allyl acetate, allyl chloride, allyl alcohol, dimethylallyl alcohol, trimethyl-(3-acrylamide-3-dimethylpropyl)-ammonium chloride, acrylamide-2-methylpropanesulfonic acid and the like can be mentioned. In addition, post-modification such as urethanation, acetalation, cyanoethylation and the like-may be applied without departing from the scope of the present invention. As EVOH (A), moreover, for example, silicon-containing EVOH described in JP-A-60-144304 may be also used.

The substituted 9,10-anthraquinone (B) having a substituent at at least one of the 2-, 3-, 6- and 7-positions and showing a percent weight loss when stood with heating at 250° C. for 60 minutes of not more than 5% (hereinafter sometimes to be simply referred to as anthraquinone (B)) to be used in the present invention needs to show a percent weight loss when stood with heating at 250° C. for 60 minutes of not more than 5% (further not more than 4%, particularly not more than 3%). When the percent weight loss when stood with heating exceeds 5%, the forming stability at 250° C. decreases, thus making achievement of the object of the present invention difficult.

The percent weight loss by heating can be determined, for example, using thermobalance TGA from the weight loss when left standing at 250° C. for 60 minutes. To be more precise, it can be determined using “thermobalance TGA TG8120” manufactured by Perkin Elmer, Inc. and the like. For the measurement of the percent weight loss by heating, anthraquinone (B) needs to be sufficiently dried before measurement, and water contained as crystal water also needs to be removed. When there is scarcely a vaporization component at a low temperature other than water, anthraquinone is left standing at 100-1200C for about 10-60 min in TGA measurement until the weight loss ceases, and then the temperature is raised to 250° C. to measure the weight loss. When there are many vaporization components at a low temperature, water in the vaporization components can be measured by a method comprising passing vaporization components generated in TGA measurement through a tube packed with calcium carbonate and confirming changes in the weight, or by sealing anthraquinone in an ampoule, retaining at 250° C. and analyzing components of the gas in the ampoule by gas chromatography-mass spectrometry (GC-MS). However, when there are many vaporization components other than water at 100-120° C., the number of such components tends to increase at 250° C. and the weight change generally far exceeds 5%.

In addition, anthraquinone (B) is also required to have a substituent at at least one of the 2-, 3-, 6- and 7-positions, and the substituent is not particularly limited and, for example, nitro group, sulfonamino group, sulfonate group and the like can be mentioned. Preferably, anthraquinone (B) having a sulfonate group as a substituent is used and for imparting the water-solubility to be mentioned later, sodium sulfonate is particularly preferable.

Of the above-mentioned anthraquinone (B), water-soluble ones are preferable in consideration of the compatibility with EVOH (A). By being water-soluble is meant solubility in water at 25° C. of not less than 0.1%.

The resin composition of the present invention contains the above-mentioned EVOH (A) and anthraquinone (B), and the content (addition) ratio thereof is not particularly limited. However, anthraquinone (B) is preferably contained in a proportion of 0.5-10 wt % relative to EVOH (A). When the content is less than 0.5 wt %, oxygen permeability increases possibly because the oxygen absorbability is degraded, and when it conversely exceeds 10 wt %, appearance is degraded and oxygen permeability again unpreferably increases possibly because gas barrier property of EVOH decreases. More preferable lower limit of the content is 1 wt %, more preferable upper limit is 8 wt % and is particularly 6 wt %.

Production of the above-mentioned resin composition is not particularly limited, and EVOH (A) and anthraquinone (B) only need to be mixed. In this case, use of EVOH having a water content of not more than 60 wt % (further 20-60 wt %, particularly 25-50 wt %, especially 25-40 wt %) as EVOH (A) is preferable because generation of a foreign substance when a film is formed is suppressed. When the water content exceeds 60 wt %, the amount of foreign substance unpreferably tends to increase possibly because water containing anthraquinone (B) is easily discharged from EVOH (A) when a film is formed.

How to obtain such water-containing EVOH (A) is not particularly limited. In general, an EVOH solution is extruded in strands into a coagulation liquid to allow coagulation thereof, which is followed by cutting to give pellets and a treatment by washing with water. The water content of EVOH can be controlled during these steps.

For the measurement of the above-mentioned water content, EVOH is weighed with an electronic balance {W1 (g)}, placed in a hot air oven dryer maintained at 150° C., dried for 5 hr, allowed to cool in a desiccator for 30 min, weighed {W2 (g)) and calculated by the following formula.
Water content (%)={(W1−W2)/W1}×100

For mixing EVOH (A) and anthraquinone (B) in the present invention, industrially, EVOH (A) and anthraquinone (B) are preferably supplied into a single screw or a twin screw melt extruder, and melt-mixed in the extruder to give a resin composition. Particularly, the use of a twin screw extruder is preferable because EVOH (A) and anthraquinone (B) are mixed well. In addition, the residence time of the resin composition in the extruder is not less than 20 seconds and desirably within 20 minutes.

Generally, the above-mentioned melt-mixed resin composition is extruded in strands, cut into pellets, dried as necessary in a dryer and the like, or, after reducing the water content by removing water from the bent part of the extruder with a vacuum pump and the like, extruded in strands and cut into pellets.

In this way, the resin composition of the present invention is obtained. In the present invention, for improving the forming stability at high temperatures, 0.001-0.5 equivalent (further 0.005-0.2 equivalent, particularly 0.01-0.1 equivalent) of an acid (C) relative to anthraquinone (B) is preferably added. The acid (C) is not particularly limited but organic acids such as acetic acid, propionic acid, butyric acid, lauric acid, stearic acid, oleic acid, behenic acid, adipic acid, benzoic acid, citric acid, nicotinic acid and the like, inorganic acids such as hydrochloric acid, sulfuric acid, sulfurous acid, carbonic acid, phosphoric acid, boric acid and the like can be mentioned. To impart forming stability for a long time, citric acid and nicotinic acid are preferable from those mentioned above.

The resin composition of the present invention may contain, in addition to the above-mentioned (A)-(C), alkali metal salts (sodium, potassium etc.) with acids (acetic acid, boric acid, phosphoric acid etc.), metal salts of alkaline earth metal, transition metal and the like, lubricants such as saturated aliphatic amide (e.g., stearic acid amide etc.), unsaturated fatty acid amide (e.g., oleic acid amide etc.), bisfatty acid amide (e.g., ethylenebisstearic acid amide etc.), fatty acid metal salt (excluding magnesium salt, calcium salt, zinc salt), low molecular weight polyolefin (e.g., low molecular weight polyethylene with molecular weight of about 500-10,000, low molecular weight polypropylene etc.) and the like, inorganic salts (e.g., hydrotalcite etc.), plasticizers (e.g., aliphatic polyhydric alcohols such as ethylene glycol, glycerine, hexanediol and the like, and the like), antioxidants, UV absorbers, crystal nucleating agents, coloring agents, antistatic agents, surfactants, desiccants, antibacterial agents, antiblocking agents (e.g., talc fine particles etc.), slipping agents (e.g., amorphous silica etc.), fillers (e.g., inorganic filler etc.), other resins (e.g., polyolefin resin, polyester resin, polyamide resin, polystyrene resin, polyvinyl chloride resin, polyvinylidene chloride, acrylic resin, vinylester resin, polyester elastomer, polyurethane elastomer, chlorinated polyethylene, chlorinated polypropylene, aromatic and aliphatic polyketone, aliphatic polyalcohol etc.) and the like, within the range not departing from the object of the present invention. However, the amount thereof does not exceed the weight of the composition. In addition, other EVOHs (EVOH having different ethylene content, saponification degree, MFR and the like) and the like may be added.

The resin composition of the present invention is useful for a multilayer structure. Such multilayer structure is explained in the following.

Such multilayer structure comprises at least one layer made from the above-mentioned resin composition and for the production of the multilayer structure, other substrate only needs to be laminated on one or both surfaces of the layer made from the resin composition. As the lamination method, for example, a method comprising melt extrusion of a thermoplastic resin on a film or sheet made from the resin composition, a method conversely comprising melt extrusion of the resin composition on the substrate made from a thermoplastic resin and the like, a method comprising co-extrusion of the resin composition and other thermoplastic resin, further, a method comprising dry laminating a film or sheet made from the resin composition and a substrate film or sheet using known adhesives such as an organic titanium compound, an isocyanate compound, a polyester compound, a polyurethane compound and the like and the like can be mentioned.

As the above-mentioned thermoplastic resin, polyolefin resin, polyester resin, polyamide resin, polystyrene resin, polyvinyl chloride resin, polyvinylidene chloride, acrylic resin, vinylester resin, polyester elastomer, polyurethane elastomer, chlorinated polyethylene, chlorinated polypropylene, aromatic and aliphatic polyketone, aliphatic polyalcohol and the like can be mentioned, and polyolefin resin, polyester resin and polyamide resin are preferably used. Of these, polyolefin resin is preferably used for the application to containers such as bottle and the like.

As such polyolefin resin, a wide range of polyolefin resins including homo or copolymers of olefins such as linear low density polyethylene (LLDPE), low density polyethylene (LDPE), very low density polyethylene (VLDPE), moderate density polyethylene (MDPE), high density polyethylene (HDPE), ethylene-vinyl acetate copolymer (EVA), ionomer, ethylene-propylene (block or random) copolymer, ethylene-acrylic acid copolymer, ethylene-acrylate copolymer, ethylene-methacrylic acid copolymer, ethylene-methacrylate copolymer, polypropylene, propylene-α-olefin (α-olefin having 4 to 20 carbon atoms) copolymer, polybutene, polypentene, polymethylpentene and the like, homo or copolymers of these olefins graft modified with unsaturated carboxylic acid or an ester thereof, blends of these and the like can be mentioned. Particularly, linear low density polyethylene (LLDPE), low density polyethylene (LDPE), very low density polyethylene (VLDPE), ethylene-vinylacetate copolymer (EVA) and ionomer are preferable in that they are superior in the bending fatigue resistance, vibration fatigue resistance and the like of the obtained laminate packaging material.

Particularly, linear low density polyethylene comprising an ethylene-α-olefin copolymer having a density of 0.86-0.95 g/cm³ is preferably used. When the density is smaller than the above-mentioned range, various mechanical properties of the laminate packaging material may be insufficient, or blocking may occur. Conversely when it is larger, the bending fatigue resistance, vibration fatigue resistance and the like may unpreferably become insufficient. As used herein, the density is measured at 20° C. according to JIS K6760, and the ethylene-α-olefin copolymer is a copolymer of ethylene and α-olefin having not more than 18 carbon atoms such as butene-1, pentene-1, 4-methylpentene-1, hexene-1, octene-1 and the like. Of these, an ethylene-α-olefin copolymer comprising α-olefin having 4 to 8 carbon atoms is preferably used.

The above-mentioned linear low density polyethylene is preferably an ethylene-α-olefin copolymer produced in the presence of a single site catalyst because the effect of the present invention can be expressed fully. A single site catalyst is a catalyst characterized in that the active site is uniform (single site), while the existing Ziegler catalyst and Phillips catalyst have non-uniform active sites and are referred to as multi-site catalysts, and representative single site catalyst includes metallocene catalyst and the like. As a specific product name, Kernel (Japan Polychem Corporation), Evolue (Mitsui Chemicals), Exact (Exxon Chemical Company), Affinity (The Dow Chemical Company) and the like can be mentioned.

As such polyamide resin, polycapramide (nylon 6), poly-ω-aminoheptanoic acid (nylon 7), poly-ω-aminononanoic acid (nylon 9), polyundecaneamide (nylon 11), polylauryl lactam (nylon 12), polyethylenediamine adipamide (nylon 26), polytetramethylene adipamide (nylon 46), polyhexamethylene adipamide (nylon 66), polyhexamethylene sebacamide (nylon 610), polyhexamethylene dodecamide (nylon 612), polyoctamethylene adipamide (nylon 86), polydecamethylene adipamide (nylon 108), caprolactam/lauryl lactam copolymer (nylon 6/12), caprolactam/ω-aminononanoic acid copolymer (nylon 6/9), caprolactam/hexamethylenediammonium adipate copolymer (nylon 6/66), lauryl lactam/hexamethylenediammonium adipate copolymer (nylon 12/66), ethylenediamine adipamide/hexamethylenediammonium adipate copolymer (nylon 26/66), caprolactam/hexamethylenediammonium adipate/hexamethylenediammonium sebacate copolymer (nylon 66/610), ethyleneammonium adipate/hexamethylenediammonium adipate/hexamethylenediammonium sebacate copolymer (nylon 6/66/610), polyhexamethylene isophthalamide, polyhexamethylene terephthalamide, hexamethylene isophthalamide/terephthalamide copolymer or these polyamide resins denatured with aromatic amines such as methylenebenzylamine, m-xylenediamine and the like, m-xylylenediammonium adipate and the like can be mentioned and in the present invention, one kind thereof or a blend of two or more kinds thereof can be used.

In addition, one wherein the carboxyl group and/or amino group on the molecule terminal of polyamide resin is adjusted (denatured) with alkylmonocarboxylic acid, alkyldicarboxylic acid, alkylmonoamine, alkyldiamine and the like can be also used.

As such polyester resin, condensation polymers comprising aromatic dicarboxylic acid or these alkyl esters and glycol as main components can be specifically mentioned, and the representative one preferably comprises ethyleneterephthalate as a major repeating unit. Moreover, it is possible to contain a copolymerizable component as long as the processability, strength and the like are not drastically impaired. As such copolymerizable component, aromatic dicarboxylic acids such as isophthalic acid, diphenyl-4,4′-dicarboxylic acid, diphenoxyethanedicarboxylic acid, 2,6-naphthalenedicarboxylic acid, 2,7-naphthalenedicarboxylic acid and the like and ester forming derivatives of these, aliphatic dicarboxylic acids such as adipic acid, sebacic acid, azelaic acid, succinic acid and the like, and ester forming derivatives of these, alicyclic dicarboxylic acids such as cyclohexanedicarboxylic acid, hexahydroterephthalic acid and the like and ester forming derivative of these, oxy acids such as p-oxybenzoic acid, oxycaproic acid and the like and ester forming derivatives of these, trimellitic acid, pyromellitic acid and the like can be mentioned for an acid component.

As the glycol component, aliphatic glycols such as diethylene glycol, trimethylene glycol, tetramethylene glycol, neopentyl glycol and the like, alicyclic glycols such as 1,4-cyclohexanedimethanol and the like, aromatic glycols such as bisphenol A, alkyleneoxide adduct of bisphenol A and the like, polyalkylene glycols such as polyethylene glycol, polypropylene glycol, polytetramethylene glycol and the like, glycerine, 1,3-propanediol, pentaerythritol and the like can be mentioned.

The ethyleneterephthalate unit content is about 75-100 mol %, preferably 85-100 mol %. Preferable intrinsic viscosity (measured in a 50 wt %/50 wt % mixed solvent of phenol and tetrachloroethane at 30° C.) is 0.5-1.3 dl/g (further 0.65-1.2 dl/g).

As a representative example, one comprising ethyleneterenaphthalate as a major repeating unit can be mentioned. It is possible to add a copolymerizable component similar to the above, and the ethyleneterenaphthalate content is about 75-100 mol %, preferably 85-98 mol %. Preferable intrinsic viscosity is 0.4-1.2 dl/g (further 0.55-1.0 dl/g).

In addition, use of a blend of the above-mentioned ethyleneterephthalate polyester resin and an ethyleneterenaphthalate resin is preferable in that the gas barrier property, UV blocking property and melt formability increase. In this case, the blending ratio is 5-90 wt %, further 15-85 wt %, of ethyleneterephthalate polyester resin, and 95-10 wt %, further 85-15 wt %, of ethyleneterenaphthalate polyester resin.

Furthermore, as long as various properties are not markedly impaired, other thermoplastic resins and additives can be added, and as the thermoplastic resin, MXD-6 nylon, polycarbonate, polyallylate, liquid crystalline polymer and the like can be mentioned.

When a formed product such as a film, a sheet and the like is once obtained from the above-mentioned resin composition, which is then extrusion-coated with other substrate or laminated with other film substrate, sheet substrate and the like using an adhesive, as long as the object of the present invention is not deviated, any substrate (paper, metal foil, non-oriented, monoaxially oriented or biaxially oriented plastic film or sheet and an inorganic material vapor deposited product thereof, woven fabric, non-woven fabric, metal cotton, wood etc.) can be used besides the above-mentioned thermoplastic resins.

The layer constitution of the multilayer structure of the present invention is not only a two layer structure of a/b, but any combination such as b/a/b, a/b/a, al/a2/b, a/b1/b2, b2/b1/a/b1/b2, b1/b2/a/b3/b4, a1/b1/a2/b2 and the like can be employed as long as it is a film, a sheet or a bottle, wherein the layer made from a resin composition is a (a1, a2, . . . ) and other substrate, such as a thermoplastic resin layer is b (b1, b2, . . . ), with particular preference given to a layer constitution of b/a/b or b2/b1/a/b1/b2. In the case of a filament, any combination is possible, wherein a and b are bimetals, core (a)-sheath (b), core (b)-sheath (a), eccentric core-in-sheath type and the like.

In the above-mentioned layer constitution, an adhesive resin layer can be formed between the respective layers as necessary. As such adhesive resin, various ones can be used. While subject to change depending on the kind of resin b, a modified olefin polymer having a carboxyl group, which is obtained by chemically bonding unsaturated carboxylic acid or an anhydride thereof to an olefin polymer (the aforementioned wide range of polyolefin resins) by addition reaction, grafting reaction and the like can be mentioned. Specifically, one kind or a mixture of two or more kinds selected from maleic anhydride grafted polyethylene, maleic anhydride grafted polypropylene, maleic anhydride grafted ethylene-propylene (block or random) copolymer, maleic anhydride grafted ethylene-ethylacrylate copolymer, maleic anhydride grafted ethylene-vinylacetate copolymer and the like can be mentioned as a preferable one. The amount of the unsaturated carboxylic acid or an anhydride thereof to be contained in a olefin polymer here is preferably 0.001-3 wt %, more preferably 0.01-1 wt %, particularly preferably 0.03-0.5 wt %. When the amount of modification in a modified product is small, adhesive property may become insufficient, and when it is conversely large, crosslinking reaction sometimes occurs to unpreferably degrade the formability. These adhesive resins may be blended with a rubber-elastomer component such as resin composition, other EVOH, polyisobutylene, ethylene-propylene rubber and the like, further a resin of layer b and the like. Particularly, by blending with a polyolefin resin different from the polyolefin resin, which is the matrix of the adhesive resin, the adhesiveness may be usefully improved.

A specific mode of the most preferable laminate structure of the above-mentioned multilayer structure in the case of a bottle is a polyethylene layer/adhesive resin layer/layer of resin composition/adhesive resin layer/polyethylene layer, polypropylene layer/adhesive resin layer/layer of resin composition/adhesive resin layer/polypropylene layer, polyester resin layer/layer of resin composition/polyester resin layer or polyester resin layer/layer of resin composition/polyester resin layer/layer of resin composition/polyester resin layer and the like can be mentioned, which comprises polyolefin resin or polyester resin in inner and outer layers. In the case of a film, polyethylene resin layer /adhesive resin layer/layer of resin composition/adhesive resin layer/polyethylene resin layer, polyethylene resin layer/adhesive resin layer/polyamide resin/layer of resin composition/adhesive resin layer/polyethylene resin layer, polyamide resin layer/layer of resin composition/polyamide resin layer, polyethylene resin layer/adhesive resin layer/polyamide resin layer/layer of resin composition /polyamide resin layer and the like can be mentioned.

The thickness of each layer of the multilayer structure varies depending on the layer constitution, the kind of b, use, form of container, required properties and the like. In general, the thickness of layer a is 5-500 μm (further 10-200 μm), that of layer b is 5-5000 μm (further 30-1000 μm), and that of adhesive resin layer is about 5-400 μm (further 10-150 μm). When layer a is less than 5 μm thick, gas barrier property becomes insufficient and control of the thickness is unstable, and when it conversely exceeds 500 μm, the bending fatigue resistance becomes inferior, the film unpreferably becomes uneconomical, and when layer b is less than 5 μm thick, the rigidity becomes insufficient, and when it conversely exceeds 5000 μm, the bending fatigue resistance becomes inferior, and the weight becomes unpreferably large. When the adhesive resin layer is less than 5 μm thick, adhesion between layers becomes insufficient, and the control of the thickness becomes unstable, and when it conversely exceeds 400 μm, the weight becomes larger and the film unpreferably becomes uneconomical.

In addition, the aforementioned various additives and modifiers, fillers, other resin and the like can be also added to improve forming processing property and various properties of each layer of the multilayer structure of the present invention, within the range that does not inhibit the effect of the present invention.

The multilayer structure is used as it is for various shapes. To improve properties of the multilayer structure, a stretch treatment is preferably applied. For such stretching, monoaxial stretching or biaxial stretching may be employed, wherein drawing at the highest ratio produces formed products such as stretch film, stretch sheet, stretch container, stretch bottle and the like, which are superior in properties and free from pinholes, cracks, inconsistent stretching, delamination and the like during stretching.

As the stretching method, roll stretching, tenter stretching, tubular stretching, stretch blowing and the like, as well as deep draw forming, vacuum pneumatic forming and the like having high draw ratio can be employed. For biaxial stretching, both simultaneous biaxial stretching method and sequential biaxial stretching method can be employed. The temperature for stretching is about 60-170° C., preferably 80-160° C.

After stretching is completed, heat setting is preferably performed sequentially. Heat setting can be performed by a known means, by heat-treating the above-mentioned stretched film at 80-170° C., preferably 100-160° C., for about 2-600 seconds while maintaining the film under tension.

When, for example, a cup or tray like multilayer container is to be obtained from a multilayer sheet or a multilayer film, draw forming method is employed. Specifically, vacuum forming method, pneumatic forming method, vacuum pneumatic forming method, plug assisting vacuum pneumatic forming method and the like can be mentioned.

When a tube or bottle like multilayer container is obtained from a multilayer parison (hollow tube-like preliminarily formed product before blowing), blow forming method is employed. Specifically, extrusion blow forming (twin-head, double station type, parison shift, rotary, accumulator, horizontal parison etc.), cold parison blow forming, injection blow forming, biaxial stretch blow forming (extrusion cold parison biaxial stretch blow forming, injection cold parison biaxial stretch blow forming, injection forming inline biaxial stretch blow forming etc.) and the like can be mentioned.

When a multilayer container is to be produced, a multilayer container can be also directly obtained using a coinjection forming machine and the like.

The thus-obtained multilayer structure may have any form such as film, sheet, tape, bottle, pipe, filament, modified cross-section extrudate and the like. In addition, the obtained multilayer structure can be applied to heat treatment, cooling treatment, rolling treatment, printing treatment, dry laminate treatment, solution or melt-coating treatment, bag making processing, deep drawing processing, boxing processing, tube processing, split processing and the like as necessary.

The containers such as cup, tray, tube, bottle and the like, bags and lids made of a stretched film, which are obtained as mentioned above are useful as various containers for general foods, seasoning such as mayonnaise, dressing and the like, fermented food such as soybean paste and the like, oil and fat food such as salad oil and the like, beverages such as juice, carbonated beverage, beer, wine and the like, cosmetic, pharmaceutical products, detergent, flagrance cosmetic, industrial drugs, agricultural chemicals, fuel and the like. The multilayer structure of the present invention is particularly useful for containers of liquid food (including drink products) and the like. In addition, the multilayer structure of the present invention can be preferably used for packaging material for boil treatment and retort treatment.

In this way, the multilayer structure of the present invention superior in gas (oxygen) barrier property, forming stability, and further in the resistance to delamination and resistance to pinholes can be obtained. To fully express the oxygen barrier property, particularly oxygen capture ability, of the multilayer structure, the resin composition in the multilayer structure is preferably exposed to ultraviolet ray (UV) or electron beam (EB). In view of the cost of the device and running cost, use of UV irradiation is preferable. While the method of UV irradiation is not particularly limited, UV from a UV generation source such as high pressure mercury lamp, ultra-high pressure mercury lamp, carbon arc lamp, xenon lamp, metal halide lamp, chemical lamp and the like can be irradiated to the laminate structure. When the layer of the resin composition is not disposed on the surface, a highly transparent layer may be formed on the surface layer, so as to let the UV pass through to the layer of resin composition.

The irradiation amount of UV varies depending on the amount of component (B) in the resin composition, use of the laminate structure and the like, UV irradiation at about 200-5000 mJ/cm² (further 500-5000 mJ/cm²) is sufficient.

### EXAMPLES

The present invention is explained in detail by referring to Examples, which are not to be construed as limitative.

In the Examples “parts” and “%” are based on weight unless otherwise specified.

### Example 1

EVOH (A) [ethylene content 32 mol %, saponification degree 99.5 mol %, MFR-12 g/10 min (210° C., load: 2160 g)] having a water content of 35% and 9,10-anthraquinone-β-sodium sulfonate (B) [percent weight loss by heating at 250° C. for 60 min of 0.1%] were supplied to a twin screw extruder (30 mmφ, L/D=42, molten temperature 95° C.) such that the amount of 9,10-anthraquinone-β-sodium sulfonate (B) added was 3% relative to EVOH (A) without water and melt-mixed therein. The molten mixture was extruded in strands on a belt, cooled and cut with a pelletizer to give pellets of a resin composition containing the above-mentioned (A) and (B). These pellets were dried overnight in a vacuum drying machine at 90° C. and further dried at 140° C. for 4 hr in a fluidized dryer under a nitrogen stream.

Using the obtained resin composition (pellet) and according to the following, a multilayer structure was formed and subjected to evaluation.

[Production of Multilayer Structure-Multilayer Film]

The obtained resin composition (pellet), polyethylene [high density polyethylene, Novatec HD HB431 manufactured by Japan Polychem Corporation, MFR 0.35 g/10 min (190° C., load 2160 g)], and an adhesive resin (high density polyethylene modified with maleic anhydride, Modic AP H521 manufactured by Mitsubishi Chemical Corporation) were supplied to a multilayer extrusion device having a multilayer T die equipped with feed block 3 kinds 5 layers and co-extruded at a processing temperature of die temperature 250° C. to give a multilayer structure (multilayer film) of the present invention having a layer constitution (thickness 40/5/20/5/40 μm) of polyethylene layer/adhesive resin layer/layer of resin composition/adhesive resin layer/polyethylene layer.

The appearance, forming stability, adhesion between layers, resistance to pinholes and oxygen barrier property of the obtained multilayer film were evaluated as shown below. The forming stability was also evaluated when a multilayer structure was formed at a processing temperature of die temperature 220° C.

(Appearance)

The surface of a multilayer film was observed with a microscope, the number of foreign substances having a diameter of not less than 0.1 mm, which were present in the layer of the resin composition, was counted (per 10 cm×10 cm) and evaluated as follows.
◯ . . . 0-1
Δ . . . 2-5
× . . . not less than 6
   (Forming Stability)

The torque of the extruder after 1 hr and 10 hr from the start of the production of the above-mentioned multilayer film was examined for 10 min and the stability (%) was calculated from the average value and evaluated as follows.
Stability (%)={|torque after 10 hr−torque after 1 hr|/torque after 1 hr}×100
◯ . . . less than 10%
Δ . . . 10%—less than 15%
× . . . not less than 15%
   (Adhesion Between Layers)

A multilayer film was cut into a rectangle of 1 cm in the MD direction and 10 cm in the TD direction, and the peel strength (g/cm) of the adhesive resin layer and the layer of resin composition was measured at 23° C. in a 50% RH atmosphere by T peel method (tension speed of 100 mm/min).

(Resistance to Pinholes)

The oxygen permeability [measured using OXTRAN2/20 manufactured by MOCON by an isobaric method (MOCON method) under conditions of 23° C., 80% RH] of a multilayer film after 500 times of bending by Gelbo flex tester was measured, the ratio of oxygen permeability relative to the measure before bending (oxygen permeability after bending/oxygen permeability before bending) was calculated, and evaluated as follows.
◯ . . . less than 1.2
Δ . . . 1.2—less than 2.0
× . . . not less than 2.0
   (Oxygen Barrier Property)

The oxygen permeation of a multilayer film after irradiation of UV in an energy amount of 1000 mJ/cm² at 23° C., 80% RH was measured according to the above-mentioned method and the number of days until integrated oxygen permeation exceeded 5 cc per 1 m² was counted.

### Example 2

In the same manner as in Example 1 except that the amount of 9,10-anthraquinone-o-sodium sulfonate (B) added in the preparation of the resin composition (pellet) was 1.5% of EVOH (A), which was free of water, a multilayer structure (multilayer film) was produced and subjected to the evaluation.

### Example 3

In the same manner as in Example 1 except that 0.05 equivalent of nicotinic acid was added as acid (C) relative to 9,10-anthraquinone-β-sodium sulfonate (B) in the preparation of the resin composition (pellet), a multilayer structure (multilayer film) was produced and subjected to the evaluation.

### Example 4

In the same manner as in Example 3 except that EVOH [ethylene content 44 mol %, saponification degree 99.8 mol %, MFR 12 g/10 min (210° C., load: 2160 g)] having a water content 30% was used as EVOH (A) in the preparation of the resin composition (pellet), a multilayer structure (multilayer film) was produced and subjected to the evaluation.

### Example 5

In the same manner as in Example 1 except that 9,10-anthraquinone-2,6-di(sodium sulfonate) [percent weight loss by heating at 250° C. for 60 min of 0.1%] was used instead of 9,10-anthraquinone-β-sodium sulfonate in the preparation of the resin composition (pellet), a multilayer structure (multilayer film) was produced and subjected to the evaluation.

### Example 6

In the same manner as in Example 1 except that EVOH (A) [ethylene content 32 mol %, saponification degree 99.5 mol %, MFR 12 g/10 min (210° C., load: 2160 g)] having a water content of 0.3% was used as EVOH (A) and melt-mixed at a melting temperature of 230° C. in the preparation of the resin composition (pellet), a multilayer structure (multilayer film) was produced and subjected to the evaluation.

### Comparative Example 1

In the same manner as in Example 1 except that 9,10-anthraquinone-β-sodium sulfonate (B) was not added in the preparation of the resin composition (pellet), a multilayer structure (multilayer film) was produced and subjected to the evaluation.

### Comparative Example 2

When preparing a resin composition (pellet), 2-t-butyl-9,10-anthraquinone (B) [percent weight loss by heating at 250° C. for 60 min of 95%] was used instead of 9,10-anthraquinone-β-sodium sulfonate (B) and melt-kneaded with EVOH (A) having a water content of 35%, but uniform melt-kneading was not achieved. Therefore, in the same manner as in Example 1 except that 2-t-butyl-9,10-anthraquinone (B) was melt kneaded with EVOH (A) having a water content of 0.2% at a melting temperature of 230° C., a multilayer structure (multilayer film) was produced and subjected to the evaluation. The pellet had a water content of 0.15%, and did not require drying.

### Comparative Example 3

When preparing a resin composition (pellet), LDPE (Novatec LDLF660H manufactured by Japan Polychem Corporation) was used instead of EVOH (A) and melt-kneaded at a melting temperature of 95° C., but uniform melt-kneading was not achieved. Therefore, in the same manner as in Example 1 except that the melt-kneading was performed at a melting temperature of 230° C., a multilayer structure (multilayer film) was produced and subjected to the evaluation.

### Comparative Example 4

In the same manner as in Example 1 except that reduced iron was used instead of 9,10-anthraquinone-β-sodium sulfonate (B) in the preparation of the resin composition (pellet), a multilayer structure (multilayer film) was produced and subjected to the evaluation.

The evaluation results of Examples and Comparative Examples are shown in Table 1.

TABLE 1

| | | | | adhesion | | |
|---|---|---|---|---|---|---|
| | | forming | | between | resistance | oxygen |
| | | stability | | layers | to | barrier |
| | appearance | 220° C. | 250° C. | (g/cm) | pinholes | property |
| Ex. 1 | ◯ | ◯ | Δ | 350 | ◯ | 5 days |
| Ex. 2 | ◯ | ◯ | ◯ | 320 | Δ | 3 days |
| Ex. 3 | ◯ | ◯ | ◯ | 380 | ◯ | 5 days |
| Ex. 4 | ◯ | ◯ | ◯ | 320 | ◯ | 3 days |
| Ex. 5 | ◯ | ◯ | Δ | 340 | ◯ | 5 days |
| Ex. 6 | Δ | ◯ | ◯ | 300 | ◯ | 4 days |
| Com. Ex. 1 | ◯ | ◯ | ◯ | 250 | Δ | 2 days |
| Com. Ex. 2 | ◯ | ◯ | X | 230 | Δ | 6 days |
| Com. Ex. 3 | X | X | X | 350 | * | * |
| Com. Ex. 4 | X | Δ | Δ | 60 | X | 4 days |

*Evaluation was unavailable because oxygen permeability was large and exceeded measurable upper limit.

### INDUSTRIAL APPLICABILITY

The resin composition of the present invention contains EVOH (A) and particular anthraquinone (B). Therefore, when a multilayer structure is formed, the structure is superior in appearance, oxygen barrier property, further forming stability, resistance to pinholes, adhesion between layers and the like. A multilayer structure comprising the layer of resin composition as an intermediate layer is useful for packaging of foods such as meat, ketchup, soybean paste, beer and the like.

This application is based on a patent application No. 2002-182340 filed in Japan, the contents of which are hereby incorporated by reference.

1. A resin composition comprising a saponified ethylene-vinyl acetate copolymer (A) and a substituted; 9,1 0-anthraquinone (B) having a substituent at at least one of the 2-, 3-, 6- and 7-positions and showing a percent weight loss when stood with heating at 250° C. for 60 minutes of not more than 5%.

2. The resin composition of claim 1, wherein the substituted 9,10-anthraquinone (B) having a substituent at at least one of the 2-, 3-, 6- and 7-positions and showing a percent weight loss when stood with heating at 250° C. for 60 minutes of not more than 5% is water-soluble.

3. The resin composition of claim 2, wherein substituted 9,10-anthraquinone (B) having a substituent at at least one of the 2-, 3-, 6- and 7-positions and showing a percent weight loss when stood with heating at 250° C. for 60 minutes of not more than 5% is sodium anthraquinone-sulfonate or disodium anthraquinone-disulfonate.

4. The resin composition of claim 1, wherein the content of the substituted 9,10-anthraquinone (B) having a substituent at at least one of the 2-, 3-, 6- and, 7-positions and showing a percent weight loss when stood with heating at 250° C. for 60 minutes of not more than 5% is 0.5-10 wt % relative to the saponified ethylene-vinyl acetate copolymer (A).

5. The resin composition of claim 1, further comprising an acid (C) in 0.001-0.5 equivalent of the substituted 9,10-anthraquinone (B) having a substituent at at least one of the 2-, 3-, 6- and 7-positions and showing a percent weight loss when stood with heating at 250° C. for 60 minutes of not more than 5%.

6. The resin composition of claim 1, which is obtained by melt-mixing a saponified ethylene-vinyl acetate copolymer (A) having a water content of not more than 60 wt % and a substituted 9,10-anthraquinone (B) having a substituent at at least one of the 2-, 3-, 6- and 7-positions and showing a percent weight loss when stood with heating at 250° C. for 60 minutes of not more than 5% in an extruder.

7. A laminate structure comprising a layer made of the resin composition of claim 1 as an intermediate layer, and at least one layer of inner and outer layers comprises a resin selected from a polyolefin resin, a polyamide resin and a polyester resin.

8. The laminate structure of claim 7, wherein the inner and outer layers comprises a polyolefin resin.

9. The resin composition of claim 6, wherein the saponified ethylene-vinyl acetate copolymer (A) has a water-content of 20-60 wt %.
